(19) United States
(12) Patent Application Publication
(10) Pub. No.: US 2026/0338361 A1
(43) Pub. Date: Oct. 29, 2026

(54) MAGNETIC MOUNTING APPARATUS FOR ADJUSTABLE POSITION LIGHT FIXTURE

(71) Applicant: EmeryAllen, LLC, Mt. Pleasant, SC (US)

(72) Inventor: Thomas Garber, Daniel Island, SC (US)

(21) Appl. No.: 19/738,294

(22) Filed: Jul. 10, 2026

Related U.S. Application Data
(63) Continuation-in-part of application No. 19/576,609, filed on Mar. 24, 2026.
Application No. 19/576,609 is a continuation of application No. 19/076,279, filed on Mar. 11, 2025, now Pat. No. 12,584,617.
Application No. 19/076,279 is a continuation of application No. 18/598,953, filed on Mar. 7, 2024, now Pat. No. 12,247,725.
Application No. 18/598,953 is a continuation-in-part of application No. 18/204,284, filed on May 31, 2023, now Pat. No. 11,953,186.
Application No. 18/204,284 is a continuation-in-part of application No. 29/859,862, filed on Nov. 14, 2022, now Pat. No. D1059656.
(60) Provisional application No. 63/389,817, filed on Jul. 15, 2022.

(51) Int. Cl. F21V 21/30; F21V 23/00; H05B 45/10; F21S 8/08; F21W 131/10; F21Y 115/10

(52) U.S. Cl. CPC F21V 21/30; F21V 23/006; H05B 45/10; F21S 8/081; F21W 2131/10; F21Y 2115/10

(57) ABSTRACT

Embodiments of the present disclosure provide for a lighting fixture and magnetic mounting apparatus. The lighting fixture may comprise a base portion and a housing rotatably coupled to the base portion, wherein the housing is selectively positionable relative to the base portion and may house at least one LED and an electronics assembly. The magnetic mounting apparatus may comprise a magnetic base and a stem portion extending from the magnetic base. The stem portion may comprise a threaded portion configured to couple the magnetic mounting apparatus to the base portion of the lighting fixture. In certain embodiments, an uppermost surface of the stem portion may be flush with or recessed below an upper surface of the base portion to enable the housing to directly contact the base portion when positioned at 0 degrees.

### CROSS-REFERENCE TO RELATED APPLICATIONS

The present application is a continuation-in-part of US Patent application number 19/576,609, having a filing date of Mar. 24, 2026, and entitled, “ADJUSTABLE POSITION LIGHT EMITTING APPARATUS AND SYSTEM”; said application being a continuation of US Patent application number 19/076,279, having a filing date of Mar. 11, 2025, and entitled, “ADJUSTABLE POSITION LIGHT EMITTING APPARATUS AND SYSTEM”; said application being a continuation of US Patent application number 18/598,953, having a filing date of Mar. 7, 2024, and entitled, “ADJUSTABLE POSITION LIGHT EMITTING APPARATUS AND SYSTEM”; said application being a continuation-in-part of US Patent application number 18/204,284, having a filing date of May 31, 2023, and entitled, “ADJUSTABLE POSITION LIGHT EMITTING APPARATUS AND SYSTEM”; said application being a continuation-in-part of U.S. design application number 29/859,862 filed on Nov. 14, 2022 and entitled “MINIATURE LANDSCAPE LAMP” and said application claiming priority benefit of US Provisional application number 63/389,817, having a filing date of Jul. 15, 2022, and entitled, “ADJUSTABLE POSITION LIGHT EMITTING APPARATUS,” the entireties of which are incorporated herein at least by virtue of this reference.

### FIELD

The present disclosure relates generally to lighting fixtures and mounting apparatuses for lighting fixtures. More particularly, the present disclosure relates to adjustable light emitting apparatuses and magnetic mounting apparatuses configured to selectively support a lighting fixture on a ferrous metal surface.

### BACKGROUND

Landscape lights or outdoor lights are used in landscapes and other exterior applications to illuminate different elements of a landscape, such as plants or other structures, and/or different exterior elements such as paths and stairs. Landscape lights can be installed indoors or outdoors in different substrates such as loose, unpaved earth, concrete, stone, or wood. Some landscape light designs include a light generating module connected to a support. The support secures the landscape light to a substrate. Given the variety of exterior illumination applications in which landscape lights are used, landscape lighting apparatuses and systems must be both durable and versatile to withstand prolonged exposure to environmental elements and enable ease of installation and deployment over a wide range of substrates.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Certain aspects of the present disclosure provide for a light emitting apparatus comprising a base portion comprising a lower surface defining a circumference of the base portion, an upper surface and a retaining member extending perpendicularly from the upper surface of the base portion, the retaining member comprising a first planar surface; a cylindrical housing comprising a bottom surface and a side wall defining an exterior surface and an interior area, the cylindrical housing comprising a recessed portion disposed on an arc of the bottom surface and the side wall, the recessed portion comprising a second planar surface, wherein the base portion and the cylindrical housing are configured to be selectively interfaced such that the first planar surface of the retaining member is interfaced with the second planar surface of the recessed portion; a retaining screw extending through an aperture of the retaining member and configured to selectively secure the cylindrical housing to the base portion, wherein the cylindrical housing is configured to rotate around an axis of the retaining screw, wherein the retaining screw is configured to selectively retain the cylindrical housing to the retaining member at an angle between 0 degrees and at least 90 degrees relative to the upper surface of the base portion; at least one LED housed in the interior area of the cylindrical housing; an electronics assembly housed in the interior area of the cylindrical housing and operably engaged with the at least one LED, the electronics assembly comprising an LED driver configured to provide a flow of power between a power supply and the at least one LED; a lens positioned above the at least one LED; and a cover portion coupled to an upper circumference of the cylindrical housing and configured to secure the lens to the cylindrical housing.

In accordance with certain embodiments of the light emitting apparatus of the present disclosure, the bottom surface of the cylindrical housing is in direct contact with the upper surface of the base portion when the cylindrical housing is positioned at 0 degrees. The cylindrical housing may comprise a circumference that is the same as the circumference of the base portion. The base portion may comprise at least one slotted aperture configured to retain at least one screw. The at least one slotted aperture may be curved such that the base portion can be rotated around the at least one screw between at least one first angle and at least one second angle. The recessed portion of the cylindrical housing may be configured to receive the retaining member of the base portion. In certain embodiments, the retaining member may extend perpendicularly from the upper surface of the base portion at a point along the circumference of the base portion. In certain embodiments, the base portion may comprise a circular aperture configured to receive a landscape spike.

Further aspects of the present disclosure provide for a light emitting apparatus comprising a cylindrical housing comprising at least one LED light assembly housed in an interior area of the cylindrical housing; a cylindrical base portion comprising a retaining member extending from an upper surface of the cylindrical base portion, wherein the cylindrical housing comprises a recessed portion extending from a bottom surface of the cylindrical housing, wherein the cylindrical housing is configured to be selectively interfaced with the cylindrical base portion such that the bottom surface of the cylindrical housing is in direct contact with the upper surface of the cylindrical base portion, wherein the recessed portion of the cylindrical housing is configured to receive the retaining member of the cylindrical base portion when the cylindrical housing is selectively interfaced with the cylindrical base portion; and a retaining screw extending through an aperture of the retaining member and interfaced with a surface of the recessed portion to selectively secure the cylindrical housing to the cylindrical base portion, wherein the cylindrical housing is configured to rotate around an axis of the retaining screw.

In accordance with certain embodiments of the light emitting apparatus of the present disclosure, the retaining member comprises a first planar surface that is perpendicular to the upper surface of the cylindrical base portion. In said embodiments, the recessed portion may comprise a second planar surface that is perpendicular to the bottom surface of the cylindrical housing. In said embodiments, the first planar surface of the retaining member may be interfaced with the second planar surface of the recessed portion when the cylindrical housing is selectively interfaced with the cylindrical base portion. In certain embodiments, the cylindrical housing may comprise a circumference that is the same as a circumference of the cylindrical base portion. In certain embodiments, the retaining screw is configured to selectively retain the cylindrical housing to the retaining member at an angle between 0 degrees and at least 90 degrees relative to the upper surface of the cylindrical base portion.

Still further aspects of the present disclosure provide for an exterior lighting system comprising a base portion comprising a lower surface defining a circumference of the base portion, an upper surface and a retaining member extending perpendicularly from the upper surface of the base portion; a cylindrical housing comprising a bottom surface and a side wall defining an exterior surface and an interior area, the cylindrical housing comprising a recessed portion disposed on the side wall of the cylindrical housing and extending from the bottom surface of the cylindrical housing, wherein the cylindrical housing is configured to be selectively interfaced with the base portion, wherein the recessed portion of the cylindrical housing is configured to receive the retaining member of the base portion when the cylindrical housing is selectively interfaced with the base portion; a retaining screw extending through an aperture of the retaining member and interfaced with a surface of the recessed portion to selectively secure the cylindrical housing to the cylindrical base portion, wherein the cylindrical housing is configured to rotate around an axis of the retaining screw; at least one LED housed in the interior area of the cylindrical housing; an electronics assembly housed in the interior area of the cylindrical housing and operably engaged with the at least one LED, the electronics assembly comprising an LED driver configured to provide a flow of power between a power supply and the at least one LED; a lens positioned above the at least one LED; and a cover portion coupled to an upper circumference of the cylindrical housing and configured to secure the lens to the cylindrical housing.

In accordance with certain embodiments, the exterior lighting system may further comprise an elongated member selectively coupled to the lower surface of the base portion. In certain embodiments, the retaining screw may be configured to selectively retain the cylindrical housing to the retaining member at an angle between 0 degrees and at least 90 degrees relative to the upper surface of the base portion. The retaining member may comprise a first planar surface that is perpendicular to the upper surface of the cylindrical base portion. In said embodiments, the recessed portion may comprise a second planar surface that is perpendicular to the bottom surface of the cylindrical housing. In said embodiments, the first planar surface of the retaining member may be interfaced with the second planar surface of the recessed portion when the cylindrical housing is selectively interfaced with the base portion.

Still further aspects of the present disclosure provide for a lighting fixture comprising a base portion comprising a lower surface defining a circumference of the base portion, an upper surface and a retaining member extending from the upper surface of the base portion; a housing comprising a bottom surface and a side wall defining an exterior surface and an interior area; and a retaining screw extending through an aperture of the retaining member and configured to selectively secure the housing to the base portion, wherein the housing is configured to rotate around an axis of the retaining screw, wherein the retaining screw is configured to selectively retain the housing to the retaining member at an angle between 0 degrees and at least 90degrees relative to the upper surface of the base portion, wherein the bottom surface of the housing is in direct contact with the upper surface of the base portion when the housing is positioned at 0 degrees.

In accordance with certain embodiments, the lighting fixture may further comprise at least one LED housed in the interior area of the housing. In certain embodiments, the lighting fixture may further comprise an electronics assembly housed in the interior area of the housing and operably engaged with the at least one LED, the electronics assembly comprising an LED driver configured to provide a flow of power between a power supply and the at least one LED. The electronics assembly may further comprise a potentiometer. The potentiometer may be operably configured to control a variable lumen output of the at least one LED. In certain embodiments, the potentiometer is selectively configurable by a user (e.g., via a mechanical interface such as a screw) to configure the variable lumen output of the at least one LED. In certain embodiments, the potentiometer is housed in the interior area of the housing.

Still further aspects of the present disclosure provide for a lighting fixture comprising a housing comprising an LED lighting assembly housed in an interior area of the housing, wherein the LED lighting assembly comprises at least one LED and an LED driver configured to provide a flow of power between a power supply and the at least one LED; a base portion comprising a retaining member extending from an upper surface of the base portion; and a retaining screw extending through an aperture of the retaining member and interfaced with a surface of the housing, wherein the housing is configured to be selectively interfaced with the base portion such that a bottom surface of the housing is in direct contact with the upper surface of the base portion when the housing is positioned at 0 degrees.

Still further aspects of the present disclosure provide for a lighting fixture comprising a base portion comprising a lower surface defining a circumference of the base portion, an upper surface and a retaining member extending from the upper surface; a housing comprising a bottom surface and a side wall defining an exterior surface and an interior area; a retaining screw extending through an aperture of the retaining member and interfaced with a portion of the exterior surface of the housing, wherein the housing is configured to be selectively interfaced with the base portion such that the bottom surface of the housing is in direct contact with the upper surface of the base portion when the housing is positioned at 0 degrees; at least one LED housed in the interior area of the housing; and an electronics assembly housed in the interior area of the housing and operably engaged with the at least one LED, the electronics assembly comprising an LED driver configured to provide a flow of power between a power supply and the at least one LED.

Further aspects of the present disclosure provide for a magnetic mounting apparatus for a lighting fixture. In accordance with certain embodiments, the magnetic mounting apparatus comprises a magnetic base comprising an upper surface and a bottom surface, wherein the magnetic base is configured to magnetically couple the magnetic mounting apparatus to a ferrous metal surface. The magnetic mounting apparatus may further comprise a stem portion extending from the upper surface of the magnetic base. The stem portion may comprise a threaded portion configured to be coupled to a base portion of the lighting fixture. In certain embodiments, the stem portion is configured to couple the magnetic base to the base portion of the lighting fixture such that the magnetic mounting apparatus supports the lighting fixture on the ferrous metal surface.

In accordance with certain embodiments of the magnetic mounting apparatus, the magnetic base may comprise a cylindrical body. In certain embodiments, the magnetic base may comprise a puck-shaped body. The stem portion may be centrally disposed on the upper surface of the magnetic base. In certain embodiments, the threaded portion of the stem portion may be configured to be received in a threaded aperture of the base portion of the lighting fixture. In certain embodiments, the stem portion may be configured such that, when the stem portion is coupled to the base portion of the lighting fixture, an uppermost surface of the stem portion is flush with or recessed below an upper surface of the base portion. In certain embodiments, the bottom surface of the magnetic base may be configured to magnetically engage the ferrous metal surface to support the lighting fixture relative to the ferrous metal surface. In certain embodiments, the magnetic mounting apparatus may be selectively removable from the base portion of the lighting fixture.

Still further aspects of the present disclosure provide for a lighting system comprising a lighting fixture and a magnetic mounting apparatus coupled to a base portion of the lighting fixture. In accordance with certain embodiments, the lighting fixture comprises a base portion comprising an upper surface; a housing comprising a bottom surface and an interior area; at least one LED housed in the interior area of the housing; and a retaining member configured to rotatably couple the housing to the base portion such that the housing is selectively positionable at an angle relative to the upper surface of the base portion. The magnetic mounting apparatus may comprise a magnetic base comprising an upper surface and a bottom surface, wherein the bottom surface is configured to magnetically couple to a ferrous metal surface, and a stem portion extending from the upper surface of the magnetic base and comprising a threaded portion coupled to the base portion of the lighting fixture. In certain embodiments, the stem portion is received by the base portion such that an uppermost surface of the stem portion is flush with or recessed below the upper surface of the base portion. In certain embodiments, the bottom surface of the housing is configured to directly contact the upper surface of the base portion when the housing is positioned at 0 degrees relative to the upper surface of the base portion without interference from the magnetic mounting apparatus.

In accordance with certain embodiments of the lighting system, the base portion may comprise a threaded aperture configured to receive the threaded portion of the stem portion. In certain embodiments, the threaded aperture may be configured to alternatively receive a threaded portion of a ground stake or an elongated support member. In certain embodiments, the magnetic mounting apparatus may be selectively interchangeable with a ground stake or an elongated support member configured to be coupled to the base portion of the lighting fixture. In certain embodiments, the magnetic mounting apparatus may enable the lighting fixture to be selectively mounted to and removed from a ferrous metal surface without requiring a fastener to penetrate the ferrous metal surface.

Still further aspects of the present disclosure provide for a kit comprising a lighting fixture and a magnetic mounting apparatus configured to be selectively coupled to a base portion of the lighting fixture. In accordance with certain embodiments, the lighting fixture comprises a base portion comprising an upper surface; a housing rotatably coupled to the base portion and comprising a bottom surface and an interior area; and at least one LED housed in the interior area of the housing. The magnetic mounting apparatus may comprise a magnetic base comprising an upper surface and a bottom surface, wherein the bottom surface is configured to magnetically couple to a ferrous metal surface, and a stem portion extending from the upper surface of the magnetic base and comprising a threaded portion configured to be coupled to the base portion of the lighting fixture. In certain embodiments, the stem portion is configured to be received by the base portion such that, when the magnetic mounting apparatus is coupled to the base portion, an uppermost surface of the stem portion is flush with or recessed below the upper surface of the base portion. In certain embodiments, the housing is configured such that the bottom surface of the housing directly contacts the upper surface of the base portion when the housing is positioned at 0 degrees relative to the upper surface of the base portion without interference from the magnetic mounting apparatus.

The foregoing has outlined rather broadly the more pertinent and important features of the present invention so that the detailed description of the invention that follows may be better understood and so that the present contribution to the art can be more fully appreciated.

### BRIEF DESCRIPTION OF DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The system and method may be better understood from the following illustrative description with reference to the following drawings in which:

FIG. 1 is a perspective view of an adjustable light emitting apparatus, in accordance with certain aspects of the present disclosure;

FIG. 2 is a perspective view of a base portion of the adjustable light emitting apparatus, in accordance with certain aspects of the present disclosure;

FIG. 3 is an exploded view of the adjustable light emitting apparatus, in accordance with certain aspects of the present disclosure;

FIG. 4 is a perspective view of the adjustable light emitting apparatus coupled to a garden stake, in accordance with certain aspects of the present disclosure;

FIG. 5 is a perspective view of the adjustable light emitting apparatus coupled to a garden stake, in accordance with certain aspects of the present disclosure;

FIG. 6 is a perspective view of the adjustable light emitting apparatus coupled to a garden stake, in accordance with certain aspects of the present disclosure;

FIG. 7 is a perspective view of the adjustable light emitting apparatus, in accordance with certain aspects of the present disclosure;

FIGS. 8A-8B are plan views of an adjustable light emitting apparatus, in accordance with certain aspects of the present disclosure;

FIGS. 9A-9B are perspective views of an adjustable light emitting apparatus, in accordance with certain aspects of the present disclosure;

FIG. 10 is a perspective view of the adjustable light emitting apparatus with a removable cowl assembly, in accordance with certain aspects of the present disclosure;

FIG. 11 is a perspective view of a magnetic mounting apparatus, in accordance with certain aspects of the present disclosure;

FIG. 12 is a side elevation view of the magnetic mounting apparatus, in accordance with certain aspects of the present disclosure;

FIG. 13 is a top plan view of the magnetic mounting apparatus, in accordance with certain aspects of the present disclosure;

FIG. 14 is a bottom plan view of the magnetic mounting apparatus, in accordance with certain aspects of the present disclosure;

FIG. 15 is a perspective view of the magnetic mounting apparatus coupled to a base portion of an adjustable light emitting apparatus, in accordance with certain aspects of the present disclosure; and

FIG. 16 is a perspective view of the adjustable light emitting apparatus supported on a ferrous metal surface by the magnetic mounting apparatus, in accordance with certain aspects of the present disclosure.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. All definitions, as defined and used herein, should be understood to control over dictionary definitions, definitions in documents incorporated by reference, and/or ordinary meanings of the defined terms.

Following below are more detailed descriptions of various concepts related to, and embodiments of, inventive methods, devices and systems configured to provide for a lighting fixture comprising a base portion comprising a lower surface defining a circumference of the base portion, an upper surface and a retaining member extending from the upper surface; a housing comprising a bottom surface and a side wall defining an exterior surface and an interior area; a retaining screw extending through an aperture of the retaining member and interfaced with a portion of the exterior surface of the housing, wherein the housing is configured to be selectively interfaced with the base portion such that the bottom surface of the housing is in direct contact with the upper surface of the base portion when the housing is positioned at 0 degrees; at least one LED housed in the interior area of the housing; and an electronics assembly housed in the interior area of the housing and operably engaged with the at least one LED, the electronics assembly comprising an LED driver configured to provide a flow of power between a power supply and the at least one LED and a potentiometer operably engaged with the LED driver to control a variable lumen output (i.e., brightness) for the at least one LED.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. The present disclosure should in no way be limited to the exemplary implementation and techniques illustrated in the drawings and described below.

Where a range of values is provided, it is understood that each intervening value, to the tenth of the unit of the lower limit unless the context clearly dictates otherwise, between the upper and lower limit of that range and any other stated or intervening value in that stated range is encompassed by the invention. The upper and lower limits of these smaller ranges may independently be included in the smaller ranges, and are also encompassed by the invention, subject to any specifically excluded limit in a stated range. Where a stated range includes one or both of the endpoint limits, ranges excluding either or both of those included endpoints are also included in the scope of the invention.

As used herein, “exemplary” means serving as an example or illustration and does not necessarily denote ideal or best.

As used herein, the term “includes” means includes but is not limited to, the term “including” means including but not limited to. The term “based on” means based at least in part on.

As used herein, the term “interface” means any shared boundary or connection between two dissimilar objects, devices or systems through which information or power is passed and/or a mechanical, functional and/or operational relationship is established and/or accomplished. Such shared boundary or connection may be physical, electrical, logical and/or combinations thereof.

As used herein, the term “LED” refers to any type of light source comprising a light-emitting diode. A light-emitting diode is a semiconductor light source that emits light when current flows through it.

As used herein, the term “magnetic” refers to a structure, material, component, or assembly configured to generate, provide, or otherwise utilize a magnetic attraction force. A magnetic component may comprise one or more permanent magnets, electromagnets, ferromagnetic materials, or combinations thereof.

As used herein, the term “ferrous metal surface” refers to any surface comprising a material capable of being magnetically attracted to or retained by a magnetic component. A ferrous metal surface may comprise iron, steel, another ferromagnetic material, or a structure having a magnetically engageable portion.

As used herein, the phrase “flush with or recessed below,” when used with respect to a first surface or portion relative to a second surface, means that the first surface or portion does not extend above the second surface. The first surface or portion may be substantially coplanar with the second surface or may be positioned below the second surface.

As used herein, the term “support,” when used with respect to a mounting apparatus and a lighting fixture, means to hold, retain, carry, position, suspend, or otherwise maintain the lighting fixture relative to another structure or surface. Supporting a lighting fixture does not require permanent attachment and may include selectively removable attachment.

Certain benefits and advantages of the present disclosure include a light emitting apparatus comprising a housing that is rotatably coupled to a base portion, wherein the housing is rotatably adjustable on two axes of rotation.

Further benefits and advantages of the present disclosure include a light emitting apparatus comprising a housing portion that is rotatably coupled to a base portion, wherein the housing portion may be selectively disconnected from the base.

Further benefits and advantages of the present disclosure include a light emitting apparatus comprising a housing portion that is rotatably coupled to a base portion, wherein the housing portion comprises at least one LED operably engaged with at least one LED driver to have a variable lumen output.

Further benefits and advantages of the present disclosure include a light emitting apparatus comprising a housing portion that is rotatably coupled to a base portion, wherein the housing portion comprises at least one lens portion configured to enable one or more interchangeable/ modifiable beam spread optics.

Further benefits and advantages of the present disclosure include a magnetic mounting apparatus configured to selectively support a lighting fixture on a ferrous metal surface without requiring a fastener to penetrate the ferrous metal surface.

Further benefits and advantages of the present disclosure include a magnetic mounting apparatus configured to be selectively coupled to and removed from a base portion of a lighting fixture, thereby enabling the lighting fixture to be selectively repositioned among one or more ferrous metal surfaces.

Further benefits and advantages of the present disclosure include a magnetic mounting apparatus configured to be selectively interchangeable with one or more additional support members, including a ground stake, a landscape spike, a pole, an elongated support member, or another support configured to interface with a base portion of a lighting fixture.

Further benefits and advantages of the present disclosure include a magnetic mounting apparatus comprising a stem portion configured to be received by a base portion of a lighting fixture such that an uppermost surface of the stem portion is flush with or recessed below an upper surface of the base portion, thereby enabling a bottom surface of a housing of the lighting fixture to directly contact the upper surface of the base portion when the housing is positioned at 0 degrees relative to the base portion.

Further benefits and advantages of the present disclosure include a magnetic mounting apparatus configured to support an adjustable light emitting apparatus while preserving rotational adjustment of a housing of the adjustable light emitting apparatus relative to a base portion of the adjustable light emitting apparatus.

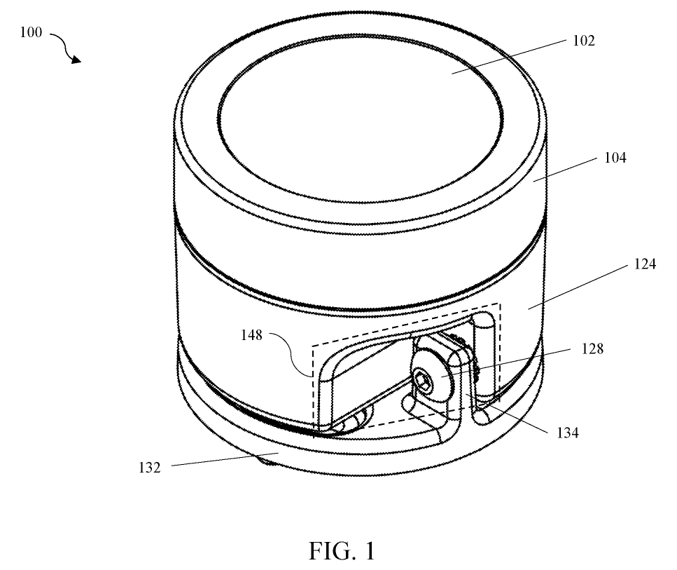

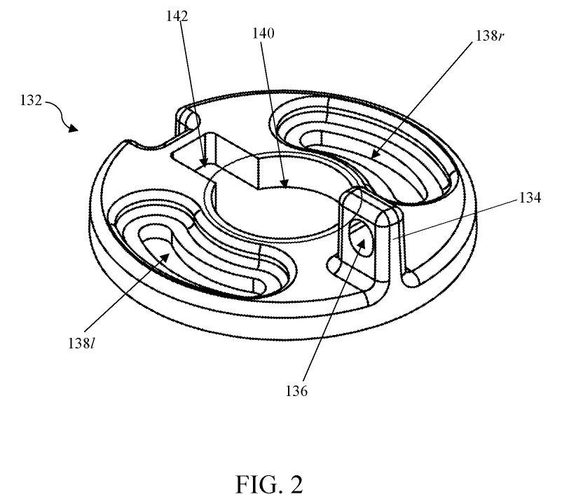

Turning now descriptively to the drawings, in which similar reference characters denote similar elements throughout the several views, FIG. 1 depicts a perspective view of an adjustable light emitting apparatus 100. In accordance with certain aspects of the present disclosure, apparatus 100 may embody an exterior lighting fixture configured to enable one or more outdoor lighting use cases. In accordance with certain aspects of the present disclosure, apparatus 100 comprises a base 132, a housing 124, a cover portion 104 and a glass cover 102. In accordance with certain embodiments, apparatus 100 may be configured as a “hockey puck” shape when a bottom surface of housing 124 is selectively interfaced with an upper surface of base 132 (e.g., substantially cylindrical). Housing 124 may comprise a recessed portion 148 disposed along a side wall of housing 124. Recessed portion 148 may comprise at least one vertical (i.e., planar) side wall extending from a bottom surface of housing 124. In accordance with certain aspects of the present disclosure, housing 124 may be selectively coupled to base 132 at a retaining member 134 of base 132 via an axis screw 128. Retaining member 134 may be configured to interface with recessed portion 148 of housing 124 such that a planar surface of retaining member 134 may be in contact with the at least one vertical (i.e., planar) side wall of recessed portion 148. In certain embodiments, housing 124 may be rotated around axis screw 128 and positioned at a desired angle relative to base 132; e.g., rotatably pivoted to enable a “clam-shell-type” movement around an axis. Axis screw 128 may be tightened to secure housing 124 to retaining member 134 and secure housing 124 at the desired angle relative to base 132. As shown in FIG. 2, base 132 and housing 124 may be configured to enable an optical axis of a visible light output from apparatus 100 to be directed in multiple directions (e.g., up, down, left and right). In accordance with certain embodiments, base 132 may comprise retaining member 134, an axis screw aperture 136 extending through retaining member 134, a left base screw channel 138l and a right base screw channel 138r, ground stake connector aperture 140 and a power cord aperture 142.

In accordance with certain embodiments, retaining member 134 may extend vertically (e.g., perpendicularly from an upper surface) of base 132. Axis screw aperture 136 may be smooth (i.e., not threaded) such that axis screw 128 (as shown in FIG. 1) may rotate freely when selectively interfaced with axis screw aperture 136 to enable selective positioning of housing 124 (as shown in FIG. 1). Left base screw channel 138l and right base screw channel 138r may be disposed along an arc of an area of base 132. Left base screw channel 138l and right base screw channel 138r may be positioned opposite from each other (e.g., a right side and a left side). In accordance with certain embodiments, left base screw channel 138l and right base screw channel 138r may each be configured to comprise a 45-degree arc. Left base screw channel 138l and right base screw channel 138r may each comprise an aperture portion extending all the way through base 132 and a channel portion extending from an upper surface of base 132 and terminating at the aperture portion. The aperture portion may be configured to receive a screw therethrough and the channel portion may be configured to recess a head of the screw received at the aperture portion such that the screw head fits flush or below the upper surface with base 132 when the screw is interfaced with the aperture portion. Ground stake connector aperture 140 may comprise a circular aperture extending through base 132 and may be configured to mateably interface with a cylindrical member (i.e., ground stake, a landscape spike or other member configured to selectively interface with base 132). Ground stake connector aperture 140 may comprise a threaded portion for receiving a compatible threaded portion of a cylindrical member. Ground stake connector aperture 140 may be configured as any suitable shape for selectively establishing a male/female interface with a secondary member. Power cord aperture 142 may comprise a slotted aperture configured to route a power cord to housing 124 (shown in FIG. 1).

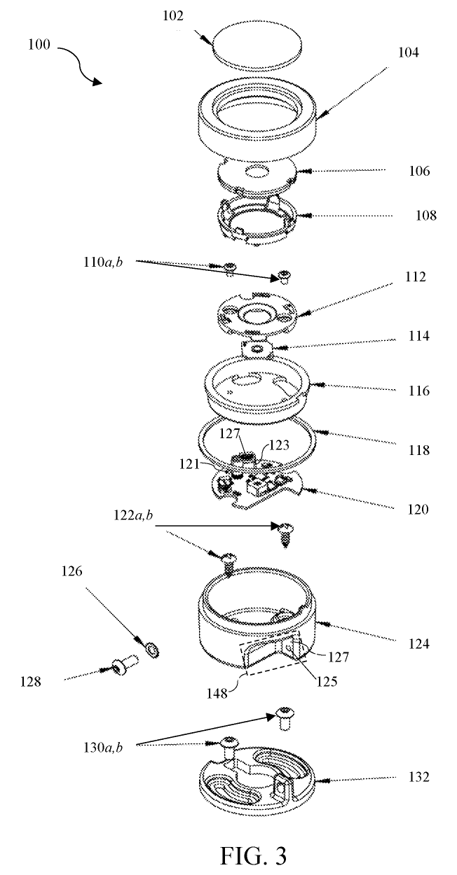

Referring now to FIG. 3, an exploded view of the adjustable light emitting apparatus 100 is shown. In accordance with certain aspects of the present disclosure, an assembly of apparatus 100 may comprise elements 102-132. In accordance with certain embodiments of the present disclosure, apparatus 100 may comprise base 132 and base screws 130a,b. Base screws 130a,b may be configured to interface with left base screw channel 138l and right base screw channel 138r (as labeled in FIG. 2) in order to secure base 132 to a target surface. Apparatus 100 may further comprise housing 124. Housing 124 may comprise a bottom surface and side walls defining an open top and an interior portion. Housing 124 may comprise a recessed portion 148 configured to receive and be selectively interfaced with the retaining member 134 (as labeled in FIG. 2). Housing 124 may comprise a screw aperture 125 disposed on a side wall 127 within the recessed portion. Axis screw 128 may extend through the axis screw aperture 136 (as labeled in FIG. 2) of the retaining member 134 (as labeled in FIG. 2) and interface with screw aperture 125 disposed on side wall 127 within the recessed portion 148 of housing 124. In accordance with certain embodiments, axis screw 128 may be selectively loosened/tightened in order to selectively position housing 124 and selectively retain housing 124 at a desired angle relative to base 132. Washer 126 may improve the interface between retaining member 134 and side wall 127 and may enhance the interface between axis screw 128 and axis screw aperture 136.

Apparatus 100 may further comprise an electronics assembly 120 comprising an LED driver 121 configured to provide a flow of power to at least one LED 114. In certain embodiments, the LED driver 121 may be configured to enable a variable lumen output for at least one LED 114. In certain embodiments, electronics assembly 120 may comprise a potentiometer 123 operably engaged with LED driver 121 to configure the variable lumen output for at least one LED 114. Potentiometer 123 may comprise a variable resistor component comprising an adjustable voltage divider configured to regulate a flow of power to at least one LED 114. Potentiometer 123 may comprise a mechanical interface 127 (e.g., a screw or a switch configured to engage a moveable wiper) that is configured to enable a user of apparatus 100 to adjust a voltage resistance in order to modify (i.e., dim or brighten) the variable lumen output for at least one LED 114.

In accordance with certain embodiments, at least one LED 114 may comprise a chip-on-board LED. At least one LED 114 may comprise a vertical optical axis relative to a bottom surface of housing 124 (e.g., a chip-on-board LED). Apparatus 100 may further comprise a packing ring 118 configured to interface with a heat sink 116. Apparatus 100 may comprise one or more housing screws 122a,b configured to secure electronics assembly 120 and heat sink 116 to housing 124. Apparatus 100 may further comprise a lens assembly comprising a lens 106, a middle lens module 108 and a lower lens module 112. The lens assembly may be housed in the interior portion of housing 124 above at least one LED 114. In certain embodiments, one or more lens module screws 110a,b may secure lower lens module 112 to heat sink 116. Apparatus 100 may further comprise a cover portion 104 configured to interface with an upper circumference of housing 124 to securely retain elements 106-120 in the interior portion of housing 124. Cover portion 104 may comprise a glass cover 102 configured to protect the interior portion of housing 124 from dirt, debris, water and other environmental elements. In accordance with certain embodiments, cover portion 104 may be rotatably engaged with lens 106 in order to manipulate one or more beam spread optics of at least one LED 114. In accordance with certain embodiments, lens 106 may be removable/replaceable to enable one or more interchangeable/modifiable beam spread optics for at least one LED 114. In certain embodiments, potentiometer 123 is housed in the interior portion of housing 124. Lens module 112 and heat sink 116 may each contain an aperture configured to expose mechanical interface 127 of potentiometer 123. In accordance with certain aspects of the present disclosure, the user may access mechanical interface 127 of potentiometer 123 upon removing cover portion 104, lens 106 and glass cover 102 from housing 124. The user may selectively adjust potentiometer 123 by inserting a tool, such as a Philips head or flathead screwdriver, through the apertures in lens module 112 and heat sink 116 to turn mechanical interface 127 to a desired position. In accordance with certain aspects of the present disclosure, upon turning mechanical interface 127 the variable resistor component is configured to regulate a flow of power to at least one LED 114 in order to configure the variable lumen output (i.e., brightness) for at least one LED 114. Upon configuring potentiometer 123 to a desired setting (i.e., the desired lumen output), the user may replace cover portion 104, lens 106 and glass cover 102 and position housing 124 to a desired angle/orientation for use.

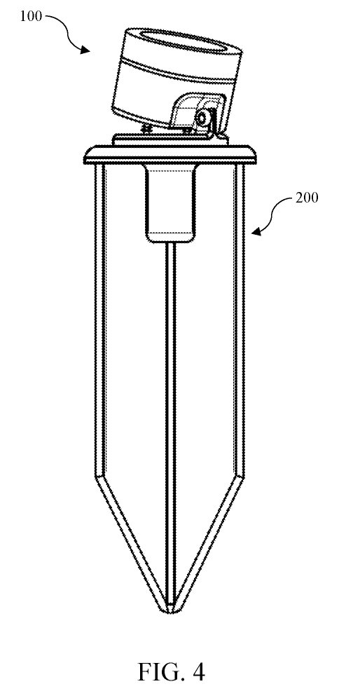

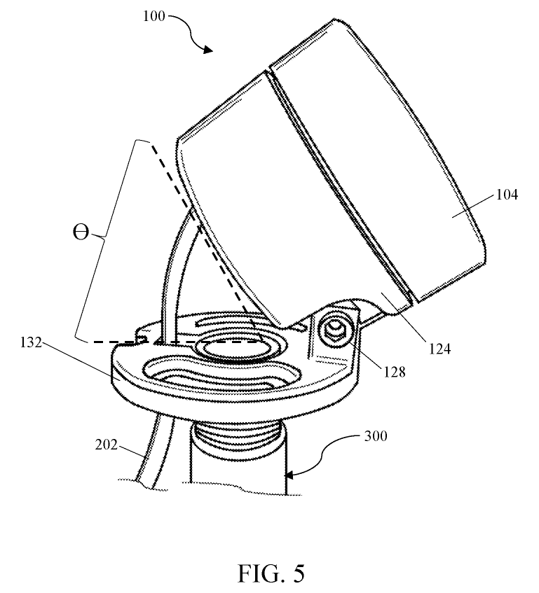

Referring now to FIGS. 4-7, perspective views of adjustable light emitting apparatus 100 are shown. In accordance with certain aspects of the present disclosure, apparatus 100 may be selectively interfaced with a garden stake 200, as shown in FIG. 4, in order to selectively install apparatus 100 in a landscape lighting use case. As shown in FIGS. 5 and 6, apparatus 100 may be selectively positioned at an angle ϴ relative to base 132 and secured in place via axis screw 128. A power supply cord 202 may extend through an aperture of base 132 and through an opening or port of housing 124 to be operably interfaced with the electronics assembly of apparatus 100 in order to power the at least one LED. As shown in FIG. 5, base 132 may be selectively coupled to an elongated member 300 (e.g., a pole or a spike) in order to enable installation of apparatus 100 in a landscape lighting use case or other outdoor lighting use case.

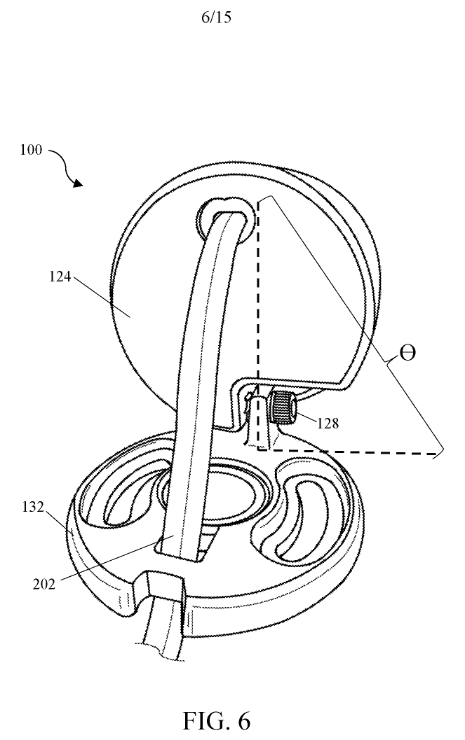

In accordance with certain aspects of the present disclosure, an optical axis of a visible light output of apparatus 100 may be positioned along an x-axis and a y-axis. Base 132 may be rotated to a desired position to direct the visible light output of apparatus 100 in a desired direction. Housing 124 may be rotatably positioned along a 180-degree arc by rotating housing 124 around axis screw 128 to a desired position along the x- and y-axis; e.g., at angle ϴ. Axis screw 128 may be selectively tightened to retain housing 124 in the desired position; e.g., at angle ϴ. As shown in FIG. 7, lens 106 may be positioned to direct/focus the beam spread optics of the visible light output from the at least one LED. In certain embodiments, cover 104 may be twisted to change a position or configuration of lens 106 in order to modify/configure one or more beam spread optics of the visible light output from the at least one LED.

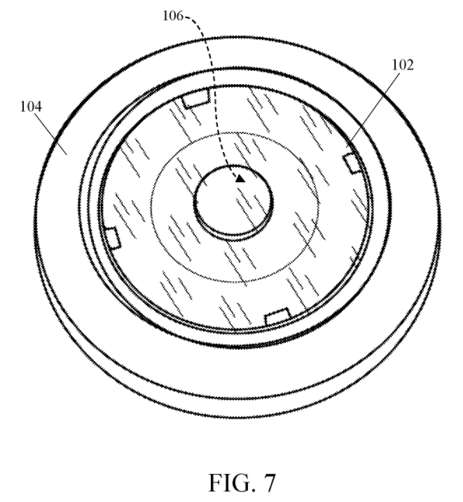

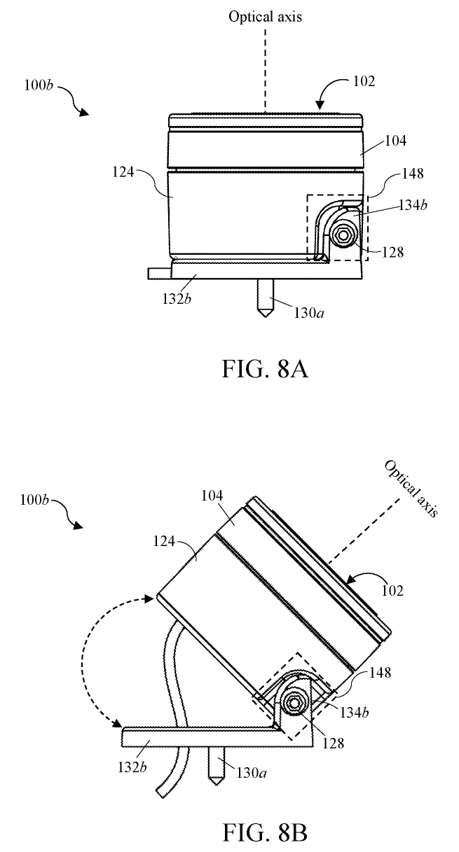

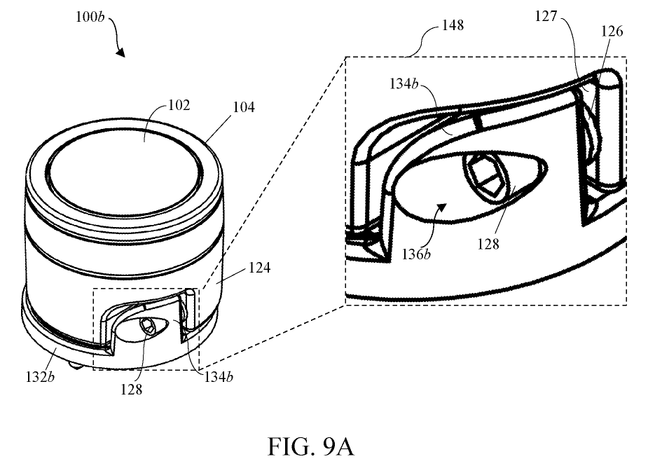

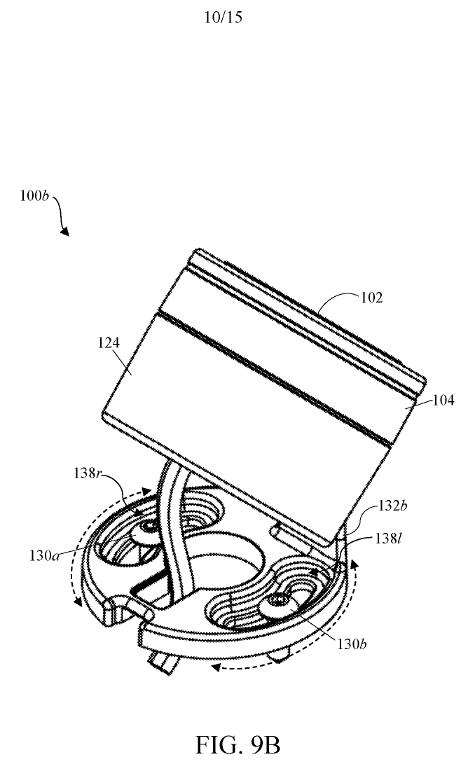

Referring now to FIGS. 8A-8B, plan views of an adjustable light emitting apparatus 100b are shown. In accordance with certain aspects of the present disclosure, apparatus 100b comprises an alternative embodiment of apparatus 100, as shown in FIGS. 1-7. In accordance with certain embodiments, apparatus 100b comprises lens 102, cover portion 104, housing 124, base 132b, and axis screw 128. Base screw 130a is also shown. Housing 124 comprises recessed portion 148. Recessed portion 148 comprises a recessed area disposed along an arc of the bottom circumference of housing 124 and comprising planar side walls and an upper surface. Recessed portion 148 is configured to receive retaining member 134b when base 132b and housing 124 are selectively coupled together via axis screw 128. In accordance with certain embodiments, base 132b comprises an alternative embodiment to base 132 (as shown in FIG. 2) in that retaining member 134b comprises an alternate form factor to retaining member 134 (as shown in FIG. 2). As shown in FIGS. 8A-8B, and shown in further detail in FIG. 9A, retaining member 134b comprises a curved upper surface configured to be interfaced with the surface of recessed portion 148. The interface between the curved upper surface of retaining member 134b and the surface of recessed portion 148 improves stability and strength between the interface of base 132b and housing 124.

As shown in FIG. 8A, apparatus 100b comprises an optical axis that is oriented vertically with respect to housing 124. In certain embodiments, apparatus 100b comprises a chip-on-board LED to generate a lighting output. Housing 124 may be rotated around retaining member 134b to a desired position between 0 degrees (e.g., as shown in FIG. 8A) and 180 degrees. Axis screw 128 may serve as an axis of rotation for housing 124. As shown in FIG. 8B, housing 124 may be rotated around retaining member 134b to direct the optical axis of apparatus 100b at a desired angle (e.g., according to the lighting application) relative to base 132b. Axis screw 128 may be loosened to enable housing 124 to be rotated to a desired position and may be tightened to secure housing 124 to retaining member 134b to retain housing 124 in the desired position. As shown in FIG. 8B, housing 124 is positioned at an angle of approximately 45 degrees relative to base 132b.

FIGS. 9A-9B are perspective views of adjustable light emitting apparatus 100b. FIG. 9A provides a magnified view of retaining member 134b and illustrates the interface between retaining member 134b and the recessed portion 148 of housing 124. As shown in FIG. 9A, the width of retaining member 134b is approximately the same as the width of recessed portion 148. Retaining member 134b comprises axis screw aperture 136b. Axis screw aperture 136b comprises an alternate form factor to axis screw aperture 136 (as shown in FIG. 2) in that axis screw aperture 136b comprises an elongated aperture such that the head of axis screw 128 is recessed within axis screw aperture 136b. Washer 126 may improve the interface between retaining member 134b and side wall 127 and may enhance the interface between axis screw 128 and axis screw aperture 136b.

As shown in FIG. 9B, apparatus 100b may be securely mounted to a desired substrate (e.g., a wood surface, a metal surface, a concrete surface, etc.) via base screws 130a,b. Base screws 130a,b may be configured to interface with left base screw channel 138l and right base screw channel 138r in order to secure base 132b to the desired substrate. Left base screw channel 138l and right base screw channel 138r may comprise curved, slotted apertures to enable base 132b to be rotated around left base screw channel 138l and right base screw channel 138r in approximately a 90-degree range of motion (i.e., 45 degrees to the left and 45 degrees to the right). Left base screw channel 138l and right base screw channel 138r may comprise slotted apertures such that the heads of base screws 130a,b are recessed within left base screw channel 138l and right base screw channel 138r such that a bottom surface of housing 124 may be directly interfaced with an upper surface of base 132b in a first configuration (as shown in FIG. 8A).

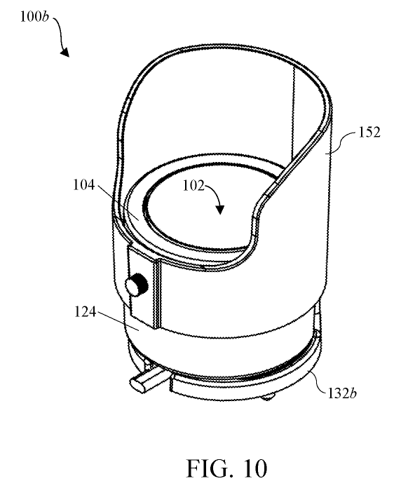

FIG. 10 is a perspective view of adjustable light emitting apparatus 100b. In accordance with certain embodiments, apparatus 100b may comprise a removable cowl assembly 152 that is friction fit to a circumference of cover portion 104 and housing 124. In accordance with certain aspects of the present disclosure, cowl assembly 152 may be utilized in certain lighting applications to direct the lighting output from apparatus 100b in a desired direction and prevent the lighting output from spilling in certain areas/directions.

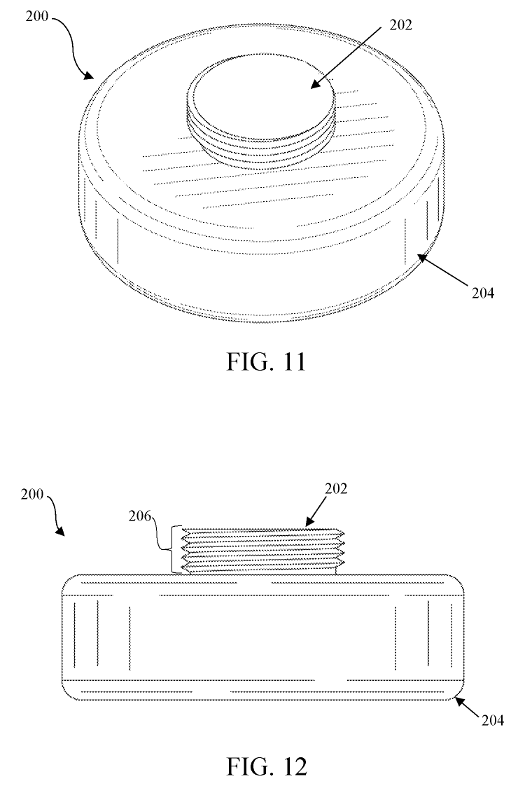

Referring now to FIGS. 11-16, various views of a magnetic mount 200 are shown. In accordance with certain aspects of the present disclosure, magnetic mount 200 may be configured to selectively support apparatus 100 on a ferrous metal surface 300. Magnetic mount 200 may be utilized as an alternative to, or in combination with, one or more additional support members described herein, including a garden stake, a landscape spike, a pole, an elongated member, a fastener-based mounting arrangement, or another support configured to interface with base 132 of apparatus 100. In certain embodiments, magnetic mount 200 may enable apparatus 100 to be selectively mounted to ferrous metal surface 300 without requiring a screw, bolt, nail, anchor, or other fastener to penetrate ferrous metal surface 300.

In accordance with certain embodiments, magnetic mount 200 may be configured as a removable accessory for apparatus 100. Magnetic mount 200 may be selectively coupled to base 132 for magnetic mounting use and selectively removed from base 132 when another mounting configuration is desired. In this manner, apparatus 100 may be installed in a first configuration using magnetic mount 200 and may be reconfigured in a second configuration using a ground stake, an elongated support member, one or more base screws, or another mounting component. Magnetic mount 200 may therefore increase the number of surfaces and environments in which apparatus 100 may be installed, including metal structures, posts, beams, housings, cabinets, equipment, rails, brackets, panels, vehicles, fixtures, or other magnetically engageable structures.

As shown in FIGS. 11-14, magnetic mount 200 may comprise a stem portion 202 and a magnetic base 204. Magnetic base 204 may comprise an upper surface 208 and a bottom surface 210. Stem portion 202 may extend from upper surface 208 of magnetic base 204. In certain embodiments, stem portion 202 may extend perpendicularly or substantially perpendicularly from upper surface 208. In certain embodiments, stem portion 202 may be centrally disposed on upper surface 208 such that a longitudinal axis of stem portion 202 is aligned with, or substantially aligned with, a central axis of magnetic base 204. In other embodiments, stem portion 202 may be offset from the central axis of magnetic base 204 to accommodate a particular base configuration, weight distribution, cable routing path, or installation geometry.

In accordance with certain embodiments, magnetic base 204 may comprise a cylindrical body. In certain embodiments, magnetic base 204 may comprise a disk-shaped body, puck-shaped body, circular body, polygonal body, rectangular body, oval body, or any other suitable form factor configured to magnetically support apparatus 100 relative to ferrous metal surface 300. Magnetic base 204 may comprise one or more magnets housed within, embedded within, adhered to, fastened to, overmolded by, or otherwise retained by magnetic base 204. In certain embodiments, magnetic base 204 may comprise a permanent magnet. In certain embodiments, magnetic base 204 may comprise a plurality of permanent magnets arranged within a body of magnetic base 204. In certain embodiments, magnetic base 204 may comprise a magnetically attractable member, a magnetic cup, a magnetic keeper, a magnet housing, a steel shell, a magnetic retaining plate, or combinations thereof configured to increase or direct a magnetic holding force.

In accordance with certain embodiments, at least a portion of magnetic base 204 may be formed from metal, polymer, rubber, elastomer, composite material, or combinations thereof. In certain embodiments, magnetic base 204 may comprise an outer covering, coating, sleeve, layer, or overmold configured to protect one or more magnets, increase friction between bottom surface 210 and ferrous metal surface 300, reduce scratching of ferrous metal surface 300, reduce corrosion, improve weather resistance, or improve impact resistance. In certain embodiments, bottom surface 210 may comprise a substantially planar contact surface configured to engage ferrous metal surface 300. In certain embodiments, bottom surface 210 may comprise a textured surface, recessed surface, raised surface, annular surface, friction-enhancing surface, compliant surface, or non-marring surface. In certain embodiments, bottom surface 210 may be configured to conform at least partially to a surface contour of ferrous metal surface 300.

Stem portion 202 may comprise a threaded portion 206. Threaded portion 206 may be configured to couple magnetic mount 200 to base 132 of apparatus 100. In certain embodiments, threaded portion 206 may be configured to be received by a threaded aperture of base 132. The threaded aperture may comprise a ground stake connector aperture, a landscape spike connector aperture, an elongated member connector aperture, or another aperture formed in base 132 and configured to receive a threaded support member. In certain embodiments, threaded portion 206 may comprise external threads configured to mate with internal threads of the threaded aperture of base 132. In other embodiments, stem portion 202 may comprise an internally threaded aperture configured to receive an externally threaded fastener or externally threaded portion of base 132. In still further embodiments, stem portion 202 may comprise any suitable coupling structure, including a bayonet connector, snap-fit connector, press-fit connector, keyed connector, friction-fit connector, quarter-turn connector, post, stud, insert, adapter, or combinations thereof.

In certain embodiments, stem portion 202 and magnetic base 204 may be integrally formed. In other embodiments, stem portion 202 may be a separate component coupled to magnetic base 204 by threading, welding, brazing, adhesive, press-fitting, overmolding, mechanical fastening, insert molding, staking, or another suitable manufacturing or assembly method. In certain embodiments, stem portion 202 may comprise metal, stainless steel, brass, aluminum, zinc, polymer, composite material, or another material suitable to provide a structural connection between magnetic base 204 and base 132. In certain embodiments, stem portion 202 may comprise a corrosion-resistant material or coating to enable outdoor use.

Referring specifically to FIG. 11, magnetic mount 200 is shown in a perspective view. Stem portion 202 extends from magnetic base 204 and comprises threaded portion 206. In accordance with certain embodiments, threaded portion 206 may be configured to be rotated into a corresponding threaded aperture of base 132. A user may couple magnetic mount 200 to apparatus 100 by aligning threaded portion 206 with the threaded aperture of base 132 and rotating magnetic mount 200 and/or apparatus 100 until threaded portion 206 is sufficiently received by base 132. In certain embodiments, magnetic mount 200 may be hand-tightened relative to base 132. In certain embodiments, magnetic mount 200 may be tightened using a tool, a wrenching surface, a slot, a recess, a knurled surface, or another engagement feature formed on magnetic mount 200 or stem portion 202.

Referring specifically to FIG. 12, magnetic mount 200 is shown in a side elevation view. Stem portion 202 may extend upwardly from upper surface 208 of magnetic base 204. Threaded portion 206 may comprise a height selected to provide sufficient threaded engagement with base 132 while maintaining a low-profile connection between magnetic mount 200 and apparatus 100. In certain embodiments, a height of stem portion 202 and/or threaded portion 206 may be selected such that, when magnetic mount 200 is coupled to base 132, an uppermost surface of stem portion 202 is flush with or recessed below an upper surface of base 132. In certain embodiments, the uppermost surface of stem portion 202 may be substantially coplanar with the upper surface of base 132. In other embodiments, the uppermost surface of stem portion 202 may be positioned below the upper surface of base 132.

In accordance with certain embodiments, configuring the uppermost surface of stem portion 202 to be flush with or recessed below the upper surface of base 132 may enable housing 124 of apparatus 100 to be positioned at 0 degrees relative to base 132 without interference from magnetic mount 200. In certain embodiments, when housing 124 is positioned at 0 degrees relative to base 132, a bottom surface of housing 124 may directly contact the upper surface of base 132. Magnetic mount 200 may be coupled to base 132 in a manner that preserves this direct contact between housing 124 and base 132. In certain embodiments, threaded portion 206 may be sized such that threaded portion 206 does not protrude above the upper surface of base 132 when magnetic mount 200 is fully seated or otherwise coupled to base 132. In certain embodiments, base 132 may comprise a counterbore, countersink, recess, or receiving cavity configured to receive an upper end of stem portion 202 and/or threaded portion 206.

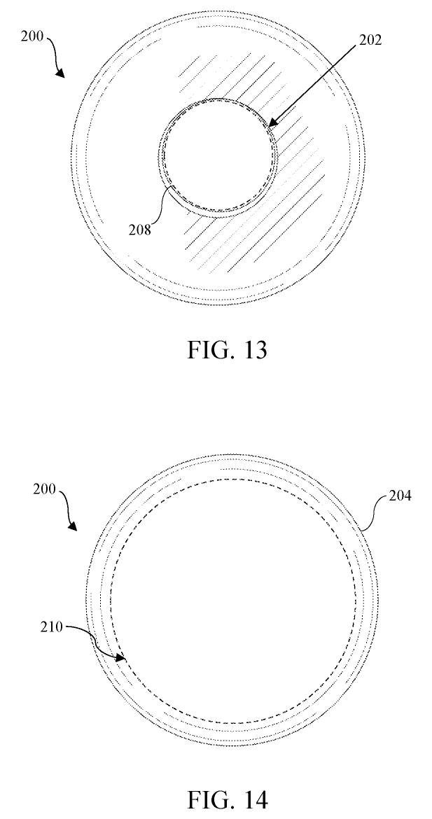

Referring specifically to FIG. 13, magnetic mount 200 is shown in a top plan view. Stem portion 202 may extend from upper surface 208 of magnetic base 204. In certain embodiments, upper surface 208 may comprise an annular surface surrounding stem portion 202. Upper surface 208 may be planar, substantially planar, curved, domed, recessed, stepped, textured, coated, or otherwise shaped. In certain embodiments, upper surface 208 may be configured to face a lower surface of base 132 when magnetic mount 200 is coupled to apparatus 100. In certain embodiments, upper surface 208 may contact the lower surface of base 132. In other embodiments, upper surface 208 may be spaced apart from the lower surface of base 132 by a washer, gasket, spacer, nut, collar, shoulder, boss, adapter, or other intermediate structure.

In certain embodiments, stem portion 202 may comprise a shoulder, stop surface, collar, flange, washer, or enlarged portion configured to limit the depth to which threaded portion 206 is received by base 132. Such a structure may assist in positioning the uppermost surface of stem portion 202 flush with or recessed below the upper surface of base 132. In certain embodiments, stem portion 202 may comprise a thread length selected to correspond to a thickness of base 132 at the threaded aperture. In certain embodiments, stem portion 202 may be configured to bottom out against a portion of base 132 before protruding above the upper surface of base 132. In other embodiments, one or more washers, spacers, jam nuts, collars, or thread-locking materials may be used to set or maintain the relative position of stem portion 202 and base 132.

Referring specifically to FIG. 14, magnetic mount 200 is shown in a bottom plan view. Bottom surface 210 of magnetic base 204 may be configured to magnetically engage ferrous metal surface 300. Bottom surface 210 may define a surface area selected to provide a desired magnetic holding force, frictional resistance, stability, and support for apparatus 100. In certain embodiments, bottom surface 210 may be circular. In other embodiments, bottom surface 210 may be square, rectangular, oval, polygonal, annular, segmented, or irregularly shaped. In certain embodiments, bottom surface 210 may be configured to engage ferrous metal surface 300 in a removable manner such that apparatus 100 may be repositioned without drilling holes in ferrous metal surface 300 or permanently altering ferrous metal surface 300.

In certain embodiments, the magnetic holding force of magnetic base 204 may be selected based on a weight of apparatus 100, an orientation of ferrous metal surface 300, an expected vibration environment, an expected wind load, an expected cable load, or other installation conditions. In certain embodiments, magnetic base 204 may be configured to support apparatus 100 when ferrous metal surface 300 is horizontal, vertical, angled, curved, inverted, overhead, or otherwise oriented. In certain embodiments, the magnetic attraction between magnetic base 204 and ferrous metal surface 300 may resist sliding, tilting, rotation, or detachment of apparatus 100 relative to ferrous metal surface 300. In certain embodiments, bottom surface 210 may comprise a friction-enhancing material or surface treatment configured to increase resistance to sliding when magnetic mount 200 is attached to ferrous metal surface 300.

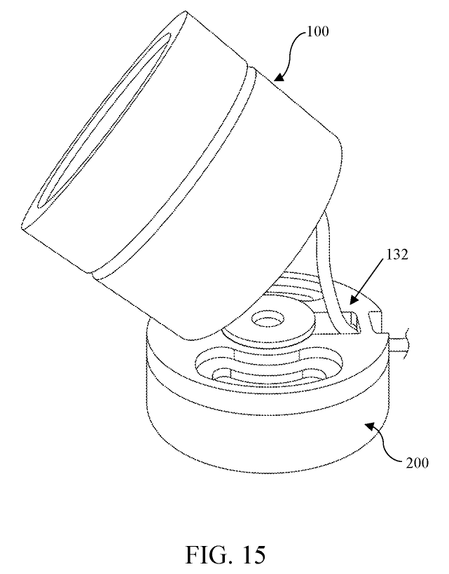

Referring now to FIG. 15, magnetic mount 200 is shown coupled to base 132 of apparatus 100. In accordance with certain embodiments, threaded portion 206 of stem portion 202 may be received by base 132 to selectively secure magnetic mount 200 to apparatus 100. Magnetic mount 200 may thereby replace or supplement another support member that may otherwise be coupled to base 132. In certain embodiments, base 132 may comprise a threaded aperture configured to alternatively receive threaded portion 206 of magnetic mount 200 and a threaded portion of a garden stake, landscape spike, pole, elongated member, or other support member. In this manner, a common interface of base 132 may support multiple installation configurations.

In certain embodiments, magnetic mount 200 may be coupled to base 132 such that magnetic base 204 is positioned below base 132 and stem portion 202 extends upwardly into base 132. When magnetic mount 200 is coupled to base 132, apparatus 100 may remain adjustable as described herein. For example, housing 124 may remain rotatable relative to base 132 around an axis of axis screw 128. In certain embodiments, magnetic mount 200 may be configured and positioned so that magnetic mount 200 does not obstruct, contact, or otherwise interfere with rotation of housing 124 relative to base 132. In certain embodiments, magnetic mount 200 may be positioned below base 132 such that base 132 continues to define the interface surface against which the bottom surface of housing 124 may directly contact when housing 124 is positioned at 0 degrees.

In accordance with certain embodiments, magnetic mount 200 may be coupled to base 132 before apparatus 100 is positioned on ferrous metal surface 300. In other embodiments, magnetic mount 200 may first be positioned on ferrous metal surface 300, and apparatus 100 may then be coupled to magnetic mount 200. In still other embodiments, magnetic mount 200 and apparatus 100 may be preassembled and provided as a lighting system or kit. Magnetic mount 200 may be selectively removable from base 132 to enable cleaning, storage, repair, replacement, reconfiguration, or selection of another mounting approach.

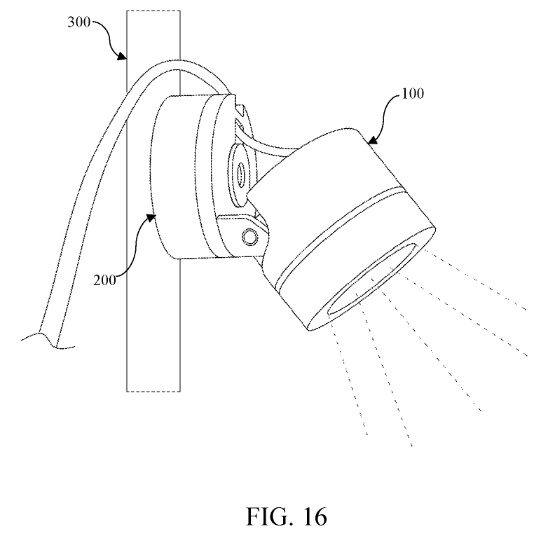

Referring now to FIG. 16, apparatus 100 is shown supported relative to ferrous metal surface 300 by magnetic mount 200. Magnetic base 204 may magnetically engage ferrous metal surface 300 to retain apparatus 100 in a desired position. Ferrous metal surface 300 may comprise any magnetically engageable surface, including a surface formed from iron, steel, ferromagnetic material, or another material or structure capable of magnetic engagement. Ferrous metal surface 300 may be part of a building structure, landscape structure, fence, post, rail, beam, panel, bracket, vehicle, equipment housing, machinery, junction box, enclosure, sign, outdoor structure, or other structure to which apparatus 100 may be mounted.

In accordance with certain embodiments, magnetic mount 200 may support apparatus 100 on ferrous metal surface 300 without requiring a fastener to penetrate ferrous metal surface 300. Magnetic mount 200 may therefore enable temporary, semi-permanent, or repositionable installation of apparatus 100. In certain embodiments, a user may remove apparatus 100 from ferrous metal surface 300 by applying a force sufficient to overcome the magnetic attraction between magnetic base 204 and ferrous metal surface 300. The user may then reposition apparatus 100 at another location on the same ferrous metal surface 300 or at a different ferrous metal surface. In certain embodiments, magnetic mount 200 may allow apparatus 100 to be installed where drilling, screwing, anchoring, staking, or permanent alteration of the mounting surface is impractical, undesirable, restricted, or unavailable.

In certain embodiments, apparatus 100 may remain adjustable while supported by magnetic mount 200. Base 132 may be oriented relative to ferrous metal surface 300 by repositioning magnetic mount 200 on ferrous metal surface 300. Housing 124 may be rotated relative to base 132 to direct an optical axis of the lighting output from apparatus 100 toward a desired target area. In certain embodiments, housing 124 may be selectively positioned at 0 degrees relative to base 132 such that the bottom surface of housing 124 directly contacts the upper surface of base 132. In certain embodiments, the flush or recessed arrangement of stem portion 202 relative to base 132 may prevent magnetic mount 200 from interfering with this 0-degree position. In certain embodiments, housing 124 may also be selectively positioned at one or more non-zero angles relative to base 132 while magnetic mount 200 supports apparatus 100 relative to ferrous metal surface 300.

In accordance with certain embodiments, magnetic mount 200 may be provided as part of a kit with apparatus 100. The kit may include apparatus 100 and magnetic mount 200. In certain embodiments, the kit may further comprise one or more additional support members, including a garden stake, a landscape spike, a pole, an elongated member, one or more screws, one or more anchors, one or more washers, one or more spacers, one or more adapters, or combinations thereof. In certain embodiments, the kit may comprise instructions for coupling threaded portion 206 of magnetic mount 200 to base 132. In certain embodiments, the kit may comprise instructions indicating that magnetic mount 200 may be coupled to base 132 such that an uppermost surface of stem portion 202 is flush with or recessed below an upper surface of base 132.

In accordance with certain embodiments, magnetic mount 200 may be used with lighting fixtures other than apparatus 100. For example, magnetic mount 200 may be configured to support any lighting fixture comprising a base portion having an aperture, threaded aperture, receiving feature, adapter, or other coupling structure compatible with stem portion 202. In certain embodiments, stem portion 202 may be dimensioned, threaded, adapted, or otherwise configured for use with a plurality of different lighting fixture bases. In certain embodiments, one or more adapters may be provided to allow magnetic mount 200 to couple to lighting fixtures having different thread sizes, aperture sizes, base thicknesses, or mounting geometries.

In accordance with certain embodiments, the dimensions, shape, material, magnetic strength, thread size, thread pitch, stem height, stem diameter, and surface configuration of magnetic mount 200 may be varied without departing from the scope of the present disclosure. For example, magnetic mount 200 may comprise a larger magnetic base 204 for heavier fixtures or high-vibration environments, a smaller magnetic base 204 for compact installations, a low-profile stem portion 202 for reduced clearance applications, or a replaceable stem portion 202 for compatibility with multiple base configurations. In certain embodiments, magnetic mount 200 may include drainage features, sealing features, corrosion-resistant coatings, non-marring surface treatments, anti-rotation features, gripping features, alignment features, or cable-routing features.

The terminology used herein is for describing particular embodiments only and is not intended to be limiting of the embodiments. As used herein, the singular forms "a," "an," and "the" are intended to include the plural forms as well, unless the context clearly indicates otherwise. It will be further understood that the terms "comprises," "comprising," "includes," and/or "including,", and variants thereof, when used herein, specify the presence of stated features, steps, operations, elements, and/or components, but do not preclude the presence or addition of one or more other features, steps, operations, elements, components, and/or groups thereof. As used herein, “exemplary” means serving as an example or illustration and does not necessarily denote ideal or best.

It will be understood that when an element is referred to as being "coupled," "connected," or "responsive" to another element, it can be directly coupled, connected, or responsive to the other element, or intervening elements may also be present. In contrast, when an element is referred to as being "directly coupled," "directly connected," or "directly responsive" to another element, there are no intervening elements present. As used herein, the term "and/or" includes any and all combinations of one or more of the associated listed items.

Spatially relative terms, such as "above," "below," "upper," "lower," "top, "bottom," and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as "below" other elements or features would then be oriented "above" the other elements or features. Thus, the term "below" can encompass both an orientation of above and below. The device may be otherwise oriented (rotated 90degrees or at other orientations) and the spatially relative descriptors used herein interpreted accordingly. Well-known functions or constructions may not be described in detail for brevity and/or clarity.

It will be understood that, although the terms "first," "second," etc. may be used herein to describe various elements, these elements should not be limited by these terms. These terms are only used to distinguish one element from another. Thus, a first element could be termed a second element without departing from the teachings of the present embodiments. Unless otherwise defined, all terms (including technical and scientific terms) used herein have the same meaning as commonly understood by one of ordinary skill in the art to which these embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention. Therefore, it will be apparent to those skilled in the art that various modifications and variations can be made to the disclosed embodiments without departing from the scope or spirit of the invention. In view of the foregoing, it is intended that the invention covers modifications and variations of this disclosure within the scope of the following claims and their equivalents.

What is claimed is:

1. A magnetic mounting apparatus for a lighting fixture, the magnetic mounting apparatus comprising: a magnetic base comprising an upper surface and a bottom surface, wherein the magnetic base is configured to magnetically couple the magnetic mounting apparatus to a ferrous metal surface; and a stem portion extending from the upper surface of the magnetic base, the stem portion comprising a threaded portion configured to be coupled to a base portion of the lighting fixture, wherein the stem portion is configured to couple the magnetic base to the base portion of the lighting fixture such that the magnetic mounting apparatus supports the lighting fixture on the ferrous metal surface.

2. The magnetic mounting apparatus of claim 1 wherein the magnetic base comprises a cylindrical body.

3. The magnetic mounting apparatus of claim 1 wherein the magnetic base is configured to support the lighting fixture on the ferrous metal surface without requiring a fastener to penetrate the ferrous metal surface.

4. The magnetic mounting apparatus of claim 1 wherein the stem portion is centrally disposed on the upper surface of the magnetic base.

5. The magnetic mounting apparatus of claim 1 wherein the threaded portion of the stem portion is configured to be received in a threaded aperture of the base portion of the lighting fixture.

6. The magnetic mounting apparatus of claim 1 wherein the stem portion is configured such that, when the stem portion is coupled to the base portion of the lighting fixture, an uppermost surface of the stem portion is flush with or recessed below an upper surface of the base portion.

7. The magnetic mounting apparatus of claim 1 wherein the bottom surface of the magnetic base is configured to magnetically engage the ferrous metal surface to support the lighting fixture relative to the ferrous metal surface.

8. The magnetic mounting apparatus of claim 1 wherein the magnetic mounting apparatus is selectively removable from the base portion of the lighting fixture.

9. A lighting system comprising: a lighting fixture comprising: a base portion comprising an upper surface; a housing comprising a bottom surface and an interior area; at least one LED housed in the interior area of the housing; and a retaining member configured to rotatably couple the housing to the base portion such that the housing is selectively positionable at an angle relative to the upper surface of the base portion; and a magnetic mounting apparatus coupled to the base portion of the lighting fixture, the magnetic mounting apparatus comprising: a magnetic base comprising an upper surface and a bottom surface, wherein the bottom surface is configured to magnetically couple to a ferrous metal surface; and a stem portion extending from the upper surface of the magnetic base and comprising a threaded portion coupled to the base portion of the lighting fixture, wherein the stem portion is received by the base portion such that an uppermost surface of the stem portion is flush with or recessed below the upper surface of the base portion, and wherein the bottom surface of the housing is configured to directly contact the upper surface of the base portion when the housing is positioned at 0 degrees relative to the upper surface of the base portion without interference from the magnetic mounting apparatus.

10. The lighting system of claim 9 wherein the magnetic base comprises a cylindrical body.

11. The lighting system of claim 9 wherein the stem portion is centrally disposed on the upper surface of the magnetic base.

12. The lighting system of claim 9 wherein the base portion comprises a threaded aperture configured to receive the threaded portion of the stem portion.

13. The lighting system of claim 12 wherein the threaded aperture is configured to alternatively receive a threaded portion of a ground stake or an elongated support member.

14. The lighting system of claim 9 wherein the magnetic mounting apparatus is configured to support the lighting fixture on the ferrous metal surface without requiring a fastener to penetrate the ferrous metal surface.

15. The lighting system of claim 9 wherein the housing is rotatable relative to the base portion around an axis of a retaining screw.

16. The lighting system of claim 15 wherein the retaining screw is configured to selectively retain the housing at an angle between 0 degrees and at least 90 degrees relative to the upper surface of the base portion.

17. The lighting system of claim 9 wherein the lighting fixture further comprises an electronics assembly housed in the interior area of the housing and operably engaged with the at least one LED.

18. A kit comprising: a lighting fixture comprising: a base portion comprising an upper surface; a housing rotatably coupled to the base portion and comprising a bottom surface and an interior area; and at least one LED housed in the interior area of the housing; and a magnetic mounting apparatus configured to be selectively coupled to the base portion of the lighting fixture, the magnetic mounting apparatus comprising: a magnetic base comprising an upper surface and a bottom surface, wherein the bottom surface is configured to magnetically couple to a ferrous metal surface; and a stem portion extending from the upper surface of the magnetic base and comprising a threaded portion configured to be coupled to the base portion of the lighting fixture, wherein the stem portion is configured to be received by the base portion such that, when the magnetic mounting apparatus is coupled to the base portion, an uppermost surface of the stem portion is flush with or recessed below the upper surface of the base portion, and wherein the housing is configured such that the bottom surface of the housing directly contacts the upper surface of the base portion when the housing is positioned at 0 degrees relative to the upper surface of the base portion without interference from the magnetic mounting apparatus.

19. The kit of claim 18 wherein the magnetic mounting apparatus is selectively interchangeable with a ground stake or an elongated support member configured to be coupled to the base portion of the lighting fixture.

20. The kit of claim 18 wherein the magnetic mounting apparatus is configured to support the lighting fixture on the ferrous metal surface without requiring a fastener to penetrate the ferrous metal surface.
